(19) United States
(12) Patent Application Publication
(10) Pub. No.: US 2015/0319110 A1
(43) Pub. Date: Nov. 5, 2015

(54) APPARATUS AND METHOD FOR PROVIDING MESSAGE BASED ON OBJECT

(71) Applicant: Electronics and Telecommunications Research Institute, Daejeon (KR)

(72) Inventors: Seung-Ik LEE, Cheongju (KR); Rock-Won KIM, Daejeon (KR)

(21) Appl. No.: 14/682,875

(22) Filed: Apr. 9, 2015

(30) Foreign Application Priority Data
Apr. 30, 2014 (KR) 10-2014-0052272

(51) Int. Cl. H04L 12/58; H04L 29/08

(52) U.S. Cl. CPC H04L 51/04; H04L 67/10

(57) ABSTRACT

An apparatus and method for providing a message based on an object are disclosed. The apparatus includes an object management unit, a message management unit, a notification processing unit, and a reading processing unit. The object management unit performs the registration, authentication and deletion of an object based on object identification information and object authentication information transmitted from a message generation terminal. The message management unit connects a first message and message control information, transmitted from the message generation terminal, to the corresponding object. The notification processing unit provides notification of the arrival of the first message to a message reception terminal based on a message notification condition included in the message control information. The reading processing unit processes the reading of the first message of the message reception terminal based on object authentication information and a message reading condition included in the message control information.

### CROSS-REFERENCE TO RELATED APPLICATION

This application claims the benefit of Korean Patent Application No. 10-2014-0052272, filed Apr. 30, 2014, which is hereby incorporated by reference herein in its entirety.

### BACKGROUND

1. Technical Field

The present disclosure relates generally to an apparatus and method for providing a message based on an object and, more particularly, to an apparatus and method for providing a message based on an object, which are capable of providing a message through the medium of an object.

2. Description of the Related Art

Recently, due to an explosive increase in the number of communication terminals that can be carried by individuals, digital messaging services via which messages can be conveniently exchanged have been popularized.

These digital messaging services include a short messaging service (SMS) via which short sentences can be exchanged, a multimedia messaging service (MMS) via which multimedia messages can be exchanged, and an instant messaging service (IMS) via which chatting can be performed.

These conventional digital messaging services are operated in such a way that a transmission terminal generates a message and then transmits the message to a server along with the identification information of a reception terminal and the server receives them and then transmits them to the reception terminal. That is, in the conventional messaging services, the transmission terminal and the reception terminal immediately exchange messages via the server and any medium, other than the server, is not present between the transmission terminal and the reception terminal.

Meanwhile, not only the above-described digital communication but also conventional and analog communication using an object as a medium has been continuously performed. A representative example thereof corresponds to a case where gifts are immediately exchanged. People still prefer the analog method using an object, such as a gift, in an important event, such as a celebration, a commemoration or the like, to the digital method. Although the conventional message transfer method has the advantage of promoting friendly emotion, intimacy and a human relationship by representing sincerity, it has the disadvantages of being unable to sufficiently transfer a user's emotion and intention due to its simple memo-type expression method, easily losing or leaking a message, and being unable to easily manage and store a message.

In connection with this, Korean Patent Application Publication No. 2010-0071611 discloses a messaging service method and apparatus.

### SUMMARY

At least one embodiment of the present invention is directed to the provision of an apparatus and method for providing a message based on an object, in which the advantages of a conventional non-electronic message transfer method have been combined with the advantages of an advanced electronic message transfer method.

At least one embodiment of the present invention is directed to the provision of an apparatus and method for providing a message based on an object, in which setting is made such that a message can be viewed only when an object is possessed.

In accordance with an aspect of the present invention, there is provided an apparatus for providing a message based on an object, including an object management unit configured to perform the registration, authentication and deletion of an object based on object identification information and object authentication information transmitted from a message generation terminal; a message management unit configured to connect a first message and message control information, transmitted from the message generation terminal, to the corresponding object; a notification processing unit configured to provide notification of the arrival of the first message to a message reception terminal based on a message notification condition included in the message control information; and a reading processing unit configured to process a request from the message reception terminal for reading the first message based on object authentication information and a message reading condition included in the message control information.

The object identification information may be information that is designated by a user or assigned by the apparatus for providing a message based on an object in order to identify the object.

The object authentication information may be information that includes at least one of the location information and image information of the object collected from the outside and the tag information attached to the object.

The reading processing unit may determine whether authentication is successful by comparing object identification information and object authentication information stored in the object management unit and message reading condition stored in the message management unit with the object authentication information and message reading condition transmitted from the message reception terminal, and then may transmit the first message.

When the registered object authentication information has been set to image information, the reading processing unit may compute similarity by comparing the registered object's image with the image transmitted from the message reception terminal, and authenticate the object authentication information if the similarity meets predefined criteria.

When the registered object authentication information has been set to tag information, the reading processing unit may compare registered tag information in the object management unit with the tag information of the object transmitted from the message reception terminal, and authenticate the object authentication information if there is a match.

When the registered object authentication information has been set to location information, the reading processing unit may compare the registered location information in the object management unit with location information transmitted from the message reception terminal, and authenticate the object authentication information if locational similarity meets predefined criteria.

The message generation terminal may include an object registration unit configured to register the object in the object management unit; a message generation unit configured to generate the first message through the medium of the object registered in the object management unit; a message control unit configured to set message control information for the generated first message; a message transmission request unit configured to request the transmission of the first message to the message reception terminal by transmitting the first message and the message control information to the message management unit; and a message reading unit configured to read a second message transmitted from the reading processing unit.

The object registration unit may include an input unit configured to receive the object identification information; a collection unit configured to collect the object authentication information; a storage unit configured to store the object identification information and the object authentication information; a communication unit configured to transmit the object identification information and the object authentication information stored in the storage unit to the object management unit, and to receive a result of the registration of the object; and a display unit configured to output the result of the registration of the object.

The message control unit may set the message control information, including: mandatory message information including object identification information, sender identification information and message content; and additional message information including object authentication information, message recipient identification information, a message notification condition and a message reading condition.

The object authentication information may be set as at least one of the image information, location information and tag information of the object, the message recipient identification information may be information used to set a terminal that receives the message, the message notification condition may be a condition used to set arrival notification that enables the message reception terminal to become aware of arrival of the first message, and the message reading condition may be a condition used to set the time, location and character string at which the message reception terminal can read the first message.

The message reading unit may include a message reception unit configured to receive notification of the arrival of the second message transmitted from the notification processing unit; an object authentication unit configured to acquire the second message and the object authentication information of an object used as a medium, to transmit the second message and the object authentication information to the reading processing unit, and to obtain the authentication of the second message and the object authentication information; a reading condition authentication unit configured to transmit the message reading condition to the reading processing unit, and to obtain authentication; and a reading unit configured to, when the object authentication information and the message reading condition have been authenticated by the reading processing unit, read the second message.

The first message and the second message may be each generated using at least any one of text, a photo, a moving image, and music.

In accordance with another aspect of the present invention, there is provided a method of providing a message based on an object, including performing, by an object management unit, the registration, authentication and deletion of an object based on object identification information and object authentication information transmitted from a message generation terminal; connecting, by a message management unit, a first message and message control information, transmitted from the message generation terminal, to the corresponding object; providing, by a notification processing unit, notification of the arrival of the first message to a message reception terminal based on a message notification condition included in the message control information; and processing, by a reading processing unit, a request from the message reception terminal for reading the first message based on object authentication information and a message reading condition included in the message control information.

Processing a request from the message reception terminal for the reading of the first message based on object authentication information and a message reading condition included in the message control information may include determining whether authentication is successful by comparing object identification information and object authentication information stored in the object management unit and a message reading condition stored in the message management unit with the object authentication information and the message reading condition transmitted from the message reception terminal, and transmitting the first message.

When the registered object authentication information has been set to image information, computing similarity by comparing the registered object's image with the image transmitted from the message reception terminal, and authenticating the object authentication information if the similarity meets predefined criteria.

When the registered object authentication information has been set to tag information, comparing registered tag information in the object management unit with the tag information of the object transmitted from the message reception terminal, and authenticating the object authentication information if there is a match.

When the registered object authentication information has been set to location information, comparing the registered location information in the object management unit with location information transmitted from the message reception terminal, and authenticating the object authentication information if locational similarity meets predefined criteria.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a system that is used to implement the present invention;

FIG. 2 is a diagram illustrating the configuration of an apparatus for providing a message based on an object according to an embodiment of the present invention;

FIG. 3 is a diagram illustrating the structure of a message transmitted from a message generation terminal to an apparatus for providing a message based on an object according to an embodiment of the present invention;

FIG. 4 is a diagram illustrating the configuration of a message generation terminal according to an embodiment of the present invention;

FIG. 5 is a diagram illustrating the detailed configuration of an object registration unit adopted in a message generation terminal according to an embodiment of the present invention;

FIG. 6 is a diagram illustrating the detailed configuration of a message reading unit adopted in a message generation terminal according to an embodiment of the present invention;

FIG. 7 is a flowchart illustrating the sequence of a method of providing a message based on an object according to an embodiment of the present invention;

FIG. 8 is a flowchart illustrating a method of providing a message based on an object when a message reception terminal is designated according to an embodiment of the present invention;

FIG. 9 is a flowchart illustrating a method of providing a message based on an object when a message reception terminal is not designated according to an embodiment of the present invention; and

FIG. 10 is an embodiment of the present invention implemented in a computer system.

### DETAILED DESCRIPTION

Embodiments of the present invention will be described in detail below with reference to the accompanying drawings. Repeated descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

An apparatus and method for providing a message based on an object according to embodiments of the present invention are described in detail below with reference to the accompanying drawings.

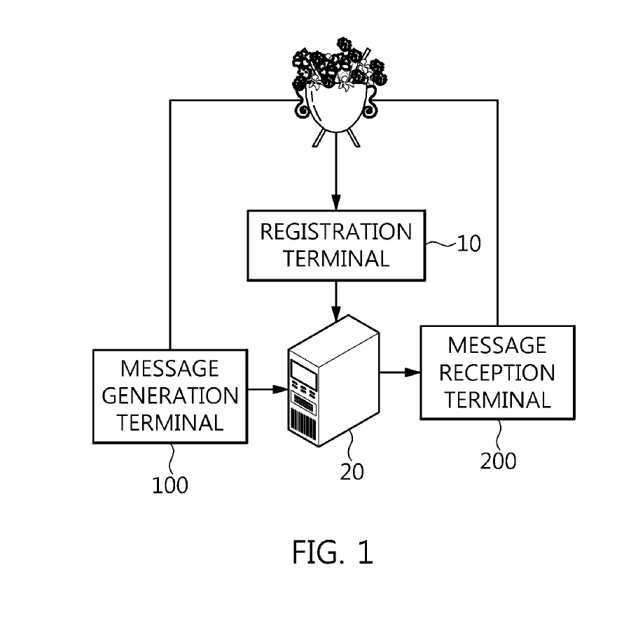

FIG. 1 is a diagram illustrating the configuration of a system that is used to implement the present invention.

Referring to FIG. 1, the system that is used to implement the present invention includes: an object; a registration terminal 10 configured to register the object; an apparatus 20 for providing a message based on an object, configured to store a message generated by a message generation terminal 100 and transfer the message to a reception terminal 200; and the message generation terminal 100 configured to generate the message, and the message reception terminal 200 configured to receive the message.

In this case, the registration terminal 10, the message generation terminal 100, and the message reception terminal 200 may be implemented using various information processing devices having a communication function. The information processing devices may each be any one of a smart phone, a mobile phone, a smart pad, or a navigation or digital broadcast receiver. It will be apparent that this is an example and the term “information processing device” corresponds to the concept including information processing devices having a communication function currently commercialized or to be developed in the future.

Furthermore, the registration terminal 10, the message generation terminal 100, and the message reception terminal 200 may correspond to a single device, or may be separate devices having distinct functions.

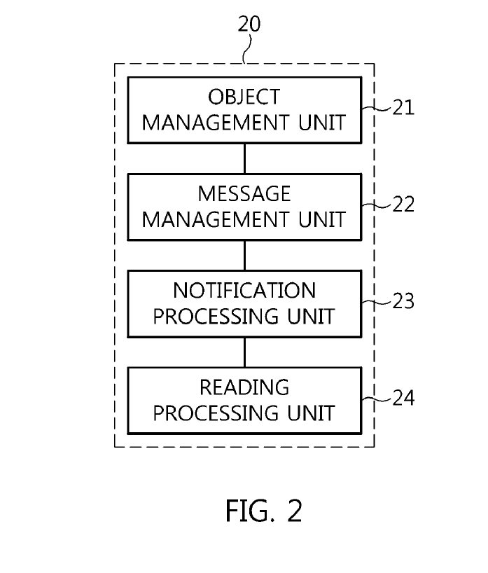

FIG. 2 is a diagram illustrating the configuration of the apparatus 20 for providing a message based on an object according to an embodiment of the present invention.

Referring to FIG. 2, the apparatus 20 for providing a message based on an object according to the present embodiment largely includes an object management unit 21, a message management unit 22, a notification processing unit 23, and a reading processing unit 24.

The object management unit 21 performs the registration, authentication and deletion of an object based on object identification information and object authentication information transmitted from an object registration unit 110.

The message management unit 22 connects a first message and message control information, transmitted from the message generation terminal 100, to the corresponding object.

The notification processing unit 23 provides first message arrival notification to the message reception terminal 200 based on a message notification condition included in the message control information.

The reading processing unit 24 processes a request from the message reception terminal 200 based on object authentication information and a message reading condition included in the message control information. The reading processing unit 24 determines whether authentication is successful by comparing the object identification information and object authentication information stored in the object management unit 21 and the message reading condition stored in the message management unit 22 with the object authentication information and message reading condition transmitted from the message reception terminal 200, and then processes the reading of the first message or second message. For example, when the object authentication information stored in object management unit 21 and the object authentication information transmitted from the message reading unit 150 are pieces of image information, the reading processing unit 24 determines that authentication is successful if the computed similarity between the two pieces of image information meets predefined criteria. When the object authentication information stored in the object management unit 21 and the object authentication information transmitted from the message reception terminal 200 are pieces of tag information, the reading processing unit 24 determines that authentication is successful if the two pieces of tag information match each other. When the object authentication information stored in the object management unit 21 and the object authentication information transmitted from the message reception terminal 200 are pieces of location information, the reading processing unit 24 determines that authentication is successful if the locational similarity meets predefined criteria.

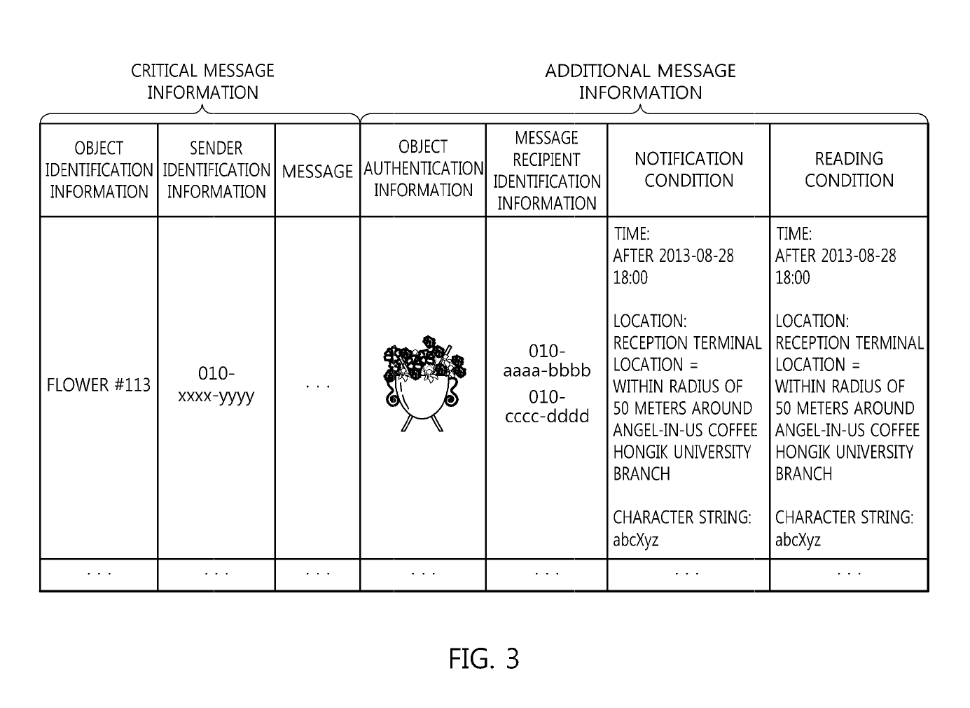

FIG. 3 is a diagram illustrating the structure of a message transmitted from a message generation terminal to an apparatus for providing a message based on an object according to an embodiment of the present invention.

Referring to FIG. 3, a message according to the present invention includes message control information, including: mandatory message information including object identification information, sender identification information, and message content; and additional message information including object authentication information, message recipient identification information, a message notification condition, and a message reading condition.

The object identification information is information that is designated by a user or assigned by the object management unit 21 in order to identify an object.

The sender identification information is information that is used to identify a sender who generates the message, and may be a communication terminal number in the case of a communication terminal.

The message content includes a title and a body.

The object authentication information may be represented in the form of at least any one of the image information, location information or tag information of an object. In the case where the object authentication information is represented in the form of the image information of an object, the message reception terminal attempts to read a message, the image information of an object is received from the message reception terminal and compared with the image information of the object registered in the object management unit 21 and the reading of the message is permitted if the computed similarity meets predefined criteria. Meanwhile, in the case where the object authentication information is represented in the form of the tag information of an object, when the message reception terminal attempts to read a message, the tag information of the object is received from the message reception terminal and compared with the tag information of the object registered in a server, and the reading of the message is permitted if there is a match. Meanwhile, in the case where the object authentication information is represented in the form of the location information of an object, when the message reception terminal attempts to read a message, the location information of an object is received from the message reception terminal and compared with the location information of the object registered in a server, and the reading of the message is permitted if the locational similarity meets predefined criteria.

The recipient identification information is at least one piece of information that is designated to identify a message recipient who will receive a message. That is, when the recipient identification information is designated in a received message, only a designated message recipient can receive the corresponding message. In this case, when a communication terminal is used for the identification information, the recipient identification information may be a communication terminal number. When the recipient identification information is not designated, any recipient or terminal can read the message.

The message notification condition is used to set a message arrival notification condition. The message notification condition includes at least one of time and location conditions. The time condition includes start time. The start time is a condition that allows notification to be provided after designated time. The location condition includes at least any one of the location of the message generation terminal, i.e., a terminal that has generated a message and the location of the message reception terminal. The current location of the message generation terminal or the message reception terminal is compared with the location condition, and is met if a preset condition is met.

The message reading condition is used to set a condition under which the message reception terminal can read the content of a message. The message reception terminal can read the message when the reading condition is met. The reading condition includes a time condition, a location condition, and a character string condition. The time condition includes at least any one of start time and termination time. The start time is a condition under which reading can be performed after designated time, and the termination time is a condition under which reading can be performed before designated time. Accordingly, when both the start time and the termination time are designated, reading can be performed within a period from the start time and the termination time. The location condition includes at least any one of the locations of the message reception terminal and the message generation terminal The current location of the location condition message generation terminal or message reception terminal is compared with the location condition, and the location condition is met if a preset condition is met. The character string condition is a character string that is used to read a message, and may be preferably used in the same sense as a password.

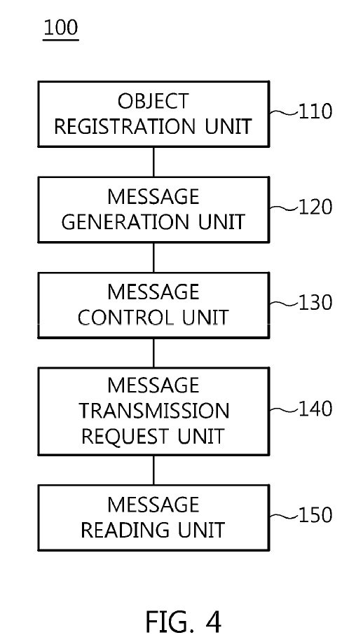

FIG. 4 is a diagram illustrating the configuration of a message generation terminal 100 according to an embodiment of the present invention.

Referring to FIG. 4, the message generation terminal 100 according to the present embodiment includes an object registration unit 110, a message generation unit 120, a message control unit 130, a message transmission request unit 140, and a message reading unit 150. In this case, the message generation terminal 100 may also perform the function of a registration terminal.

The object registration unit 110 registers an object to which an authentication means has been attached in the object management unit 21. In this case, the object may be an object to which an authentication means, such as barcode, QR code, RFID, NFC, or the like, has been attached. It will be apparent that this is an example and the term “authentication means” corresponds to the concept including all authentication media currently commercialized or to be developed in the future. The object registration unit 110 registers a corresponding object by transmitting object identification information received from a user and object authentication information collected from the outside to the object management unit 21.

The message generation unit 120 generates a first message through the medium of an object registered in the object management unit 21. In this case, the first message refers to a message that is generated and transmitted to the message reception terminal. In the following description, the term “second message” refers to a message that is generated by another message generation terminal and is then transmitted. Furthermore, the first message and the second message each include at least any one of text, a photo, a moving image, and music.

The message control unit 130 sets message control information for the generated first message. In this case, the message control information includes mandatory message information, including object identification information and sender identification information, and additional message information, including object authentication information, message reception terminal identification information, message notification condition and message reading condition.

The message transmission request unit 140 requests the transmission of the first message to the message reception terminal by transmitting the first message and the message control information to the message management unit 22.

The message reading unit 150 reads the second message transmitted from the reading processing unit 124. When notification of the arrival of the second message is received, the message reading unit 150 has the object authentication information of an object, used as a medium for the second message, and a message reading condition authenticated by the reading processing unit 124, and then reads the second message.

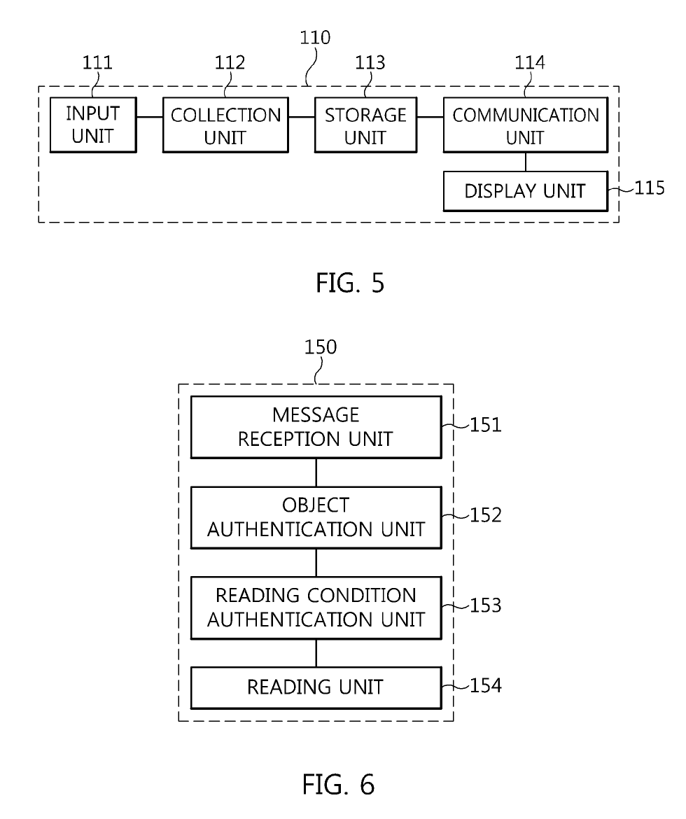

FIG. 5 is a diagram illustrating the detailed configuration of an object registration unit 110 adopted in a message generation terminal according to an embodiment of the present invention.

Referring to FIG. 5, the object registration unit 110 according to the present embodiment registers an object to which an authentication means has been attached in the object management unit 21.

For this purpose, the object registration unit 110 includes an input unit 111, a collection unit 112, a storage unit 113, a communication unit 114, and a display unit 115.

The input unit 111 receives object identification information designated by a user in order to identify the object. The input unit 111 may includes a keyboard or a mouse with which a user generates an input signal through manipulation. In this case, the object identification information may be set by being assigned by the object management unit 21.

The collection unit 112 collects object authentication information. The collection unit 112 may include a location sensor, an image sensor and a tag reader in order to collect object authentication information. The location sensor may be a Global Positioning System (GPS) sensor. The image sensor may be a camera capable of capturing a photo. The tag reader may be a device that can scan or read a barcode, a QR code, an RFID tag, or an NFC tag and interpret information contained therein. Accordingly, the collection unit 112 collects object authentication information, including at least any one of the location information of the object collected by the location sensor, the image information of the object collected by the image sensor and tag information collected by the tag reader from an authentication means that has been attached to the object.

The storage unit 113 stores the object identification information and the object authentication information. The storage unit 113 stores object identification information and object authentication information required for the registration of an object and the result of the registration of the object. The storage unit 113 may include a main storage unit, such as RAM, and an auxiliary storage unit, such as a hard disk.

The communication unit 114 transmits the object identification information and object authentication information stored in the storage unit 113 to the object management unit 21, and receives the result of the registration of the object.

The display unit 115 outputs the result of the registration of the object. The display unit 115 outputs not only the result of the registration of the object but also the object identification information and the object authentication information related to the object to be registered in the object management unit 21.

FIG. 6 is a diagram illustrating the detailed configuration of a message reading unit 150 adopted in a message generation terminal according to an embodiment of the present invention.

Referring to FIG. 6, the message reading unit 150 according to the present embodiment reads the second message transmitted from the message management unit 22.

For this purpose, the message reading unit 150 includes a message reception unit 151, an object authentication unit 152, a reading condition authentication unit 153, and a reading unit 154.

The message reception unit 151 receives an arrival notification related to the second message transmitted from the reading processing unit 24.

The object authentication unit 152 obtains authentication by acquiring the second message and the object authentication information of the object and transmitting the acquired message and information to the reading processing unit 24. The object authentication unit 152 may obtain authentication by acquiring the image information of the object using a camera and then transmitting the acquired image information to the reading processing unit 24, acquiring the location information of the object and then transmitting the acquired location information to the reading processing unit 24, or recognizing tag information attached to the object and then transmitting the tag information to the reading processing unit 24.

The reading condition authentication unit 153 obtains authentication by transmitting a message reading condition to the reading processing unit 24. The reading condition authentication unit 153 may obtain authentication by transmitting information about at least one of time, a location, and a character string to the reading processing unit 24.

When the object authentication information and the message reading condition have been authenticated by the reading processing unit 24, the reading unit 154 reads the second message. The reading unit 154 reads the content of the message using a display device.

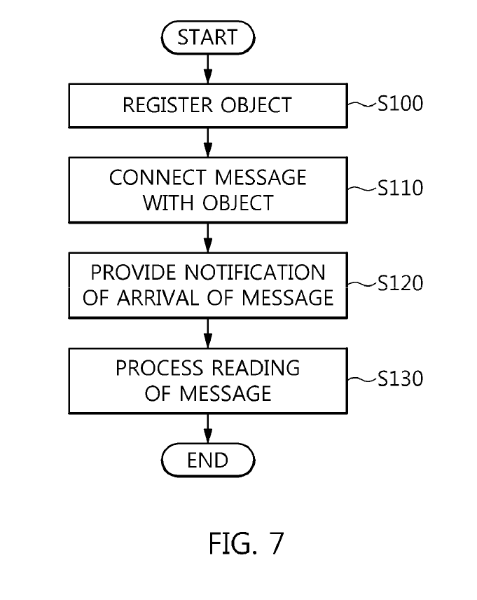

FIG. 7 is a flowchart illustrating the sequence of a method of providing a message based on an object according to an embodiment of the present invention.

Referring to FIG. 7, the method of providing a message based on an object according to the present embodiment uses an apparatus for providing a message based on an object 100, such as that described above, and thus redundant descriptions are omitted.

First, the registration, authentication and deletion of an object are performed based on object identification information and object authentication information transmitted from the message generation terminal at step S100.

Thereafter, a first message and message control information, transmitted from the message transmission request unit 140, are connected to the corresponding object at step S110.

Thereafter, notification of the arrival of the first message is provided to the message reception terminal 200 based on a message notification condition included in the message control information at step S120.

Thereafter, the first message reading of the message reception terminal 200 is processed based on object authentication information and a message reading condition included in message control information at step S130. At step S130, whether authentication is successful is determined by comparing stored object authentication information and message reading condition with the object authentication information and message reading condition transmitted from the message reception terminal or message reading unit 150, and then the reading of the first message or second message is processed.

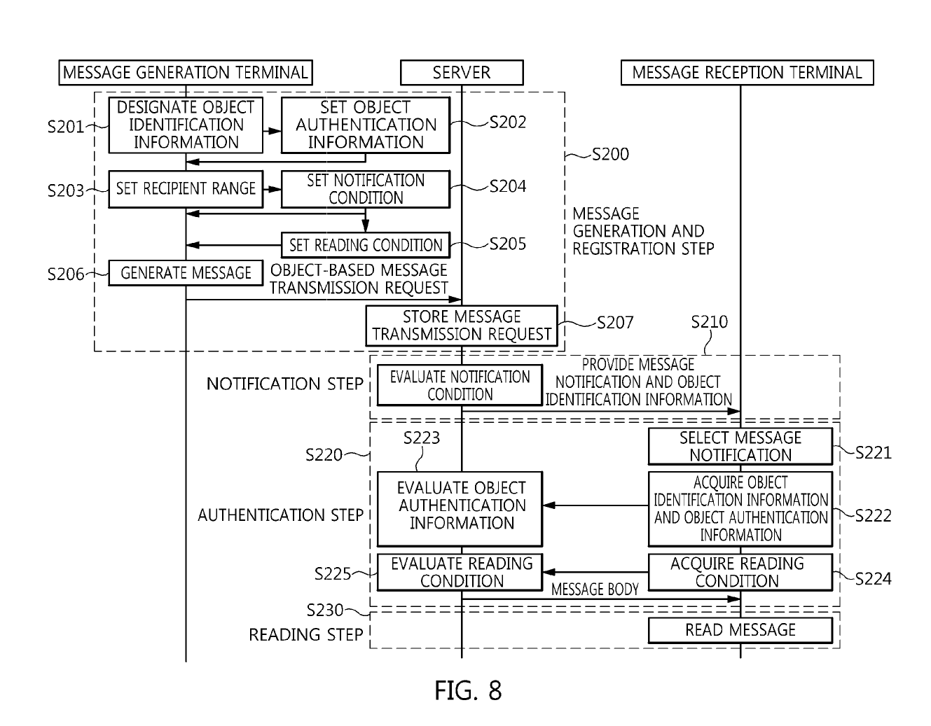

FIG. 8 is a flowchart illustrating a method of providing a message based on an object when a message reception terminal is designated according to an embodiment of the present invention.

Referring to FIG. 8, the method of providing a message based on an object when a message reception terminal is designated includes: message generation and registration step S200 of generating a message and registering the message with an object; notification step S210 of providing notification of the message based on a message notification condition set in the registered message; authentication step S220 of obtaining authentication of object authentication information and message reading condition for the reading of the message; and reading step S230 of reading the message. In this case, the agents of the steps may be the message generation terminal, the server (the apparatus for providing a message based on an object), and the message reception terminal.

In greater detail, message generation and registration step S200 of generating a message and registering the message with an object includes: object identification information designation step S201 of designating object identification information; step S202 of setting object authentication information including at least any one of the location information, image information and tag information of the object; recipient range setting step S203 of setting a range for at least one or more pieces of recipient identification information; notification condition setting step S204 of setting a message notification condition for the provision of the arrival of a message to the message reception terminal; reading condition setting step S205 of setting a message reading condition under which the message reception terminal can read a message; message generation step S206 of generating the title and body of a message; and message transmission request step S207 of requesting the transmission of a message from the message reception terminal by transmitting the generated message to the server.

Furthermore, at notification step S210 of providing notification of a message based on a message notification condition set in a registered message, the set message notification condition is evaluated. In this case, when the message notification condition is not designated or the message notification condition is met, the server provides notification of the arrival of a message to the message reception terminal based on the result of the evaluation. At this time, object identification information is transferred together.

Furthermore, authentication step S220 of obtaining authentication of object identification information, object authentication information and message reading condition for the reading of a message includes: a message notification selection step S221 at which the message reception terminal receives message notification; object authentication information acquisition step S222 of, when object authentication information has been designated in the message, acquiring object authentication information and transmitting it to the server; object authentication information evaluation step S223 at which the server compares a transmitted object authentication information with the stored object authentication information; reading condition acquisition step S224 of, when a message reading condition has been designated in the message, acquiring the message reading condition and transmitting it to the server; and reading condition evaluation step S225 at which the server compares a transmitted message reading condition with the stored message reading condition.

Finally, at reading step S230 of reading a message, when the object authentication information and the message reading condition have been authenticated and the message has been transmitted, the message reception terminal reads the message.

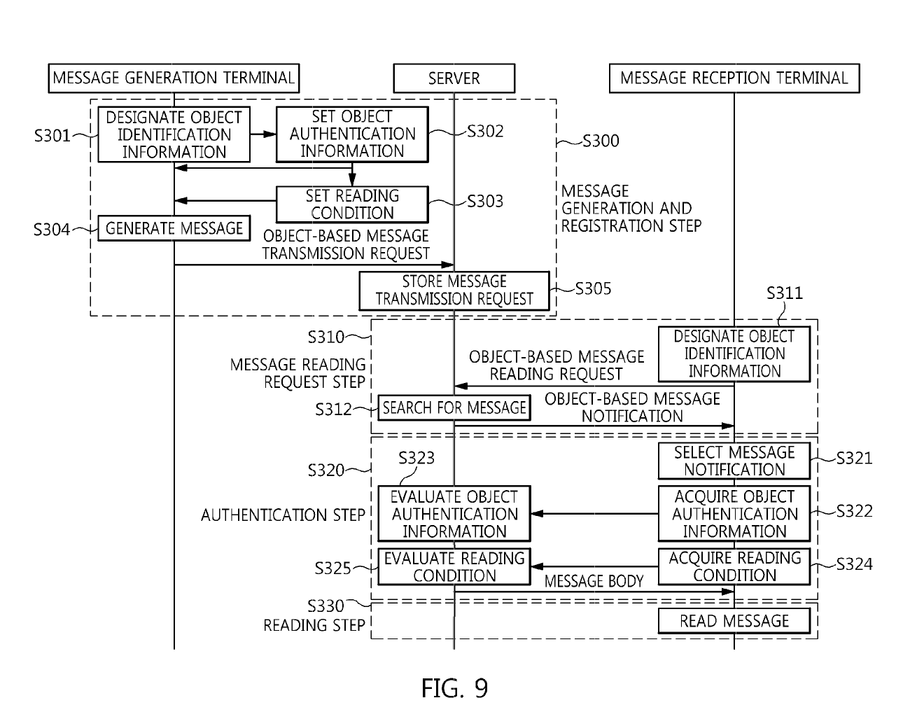

FIG. 9 is a flowchart illustrating a method of providing a message based on an object when a message reception terminal is not designated according to an embodiment of the present invention.

Referring to FIG. 9, the method of providing a message based on an object when a message reception terminal is not designated includes: message generation and registration step S300 of generating a message and registering the generated message with an object; message reading request step S310 of requesting the reading of the registered message and providing notification of the arrival of a posted message; authentication step S320 of selecting message notification and authenticating object authentication information and message reading condition set in the message; and reading step S330 of reading the message. In this case, the agents of the steps may be the message generation terminal, the server (the apparatus for providing a message based on an object) and the message reception terminal.

More specifically, message generation and registration step S300 at which the message generation terminal generates a message and registering the generated message with an object includes: object identification information designation step S301 of designating object identification information; step S302 of setting object authentication information including at least any one of the location information, image information and tag information of the object; reading condition setting step S303 of setting a message reading condition under which the message reception terminal can read a message; message generation step S304 of generating the title and body of the message; and message registration request step S305 of requesting the registration of the message by transmitting the generated message to the server.

Furthermore, message reading request step S310 of requesting the reading of the registered message and providing notification of the arrival of a posted message includes: object identification information designation step S311 of designating object identification information; and message search step S312 of searching the message registered with the object using designated object identification information. In this case, at message search step S312 of searching the message registered with the object using designated object identification information, a notification list of one or more messages for which the range of message reception terminals have not been designated is generated by searching the database of the server using the object identification information, and this list is transmitted to the message reception terminal.

Furthermore, authentication step S320 of selecting message notification and authenticating object authentication information and message reading condition set in the message includes: message notification selection step S321 at which the message reception terminal receives message notification; object authentication information acquisition step S322 of, when object authentication information has been designated in the message, acquiring object authentication information and transmitting object authentication information to the server; object authentication information evaluation step S323 at which the server compares transmitted object authentication information with previously stored object authentication information; reading condition acquisition step S324 of, when message reading condition has not been designated in the message, acquiring a message reading condition and transmitting the acquired message reading condition to the server; and reading condition evaluation step S325 at which the server compares a transmitted message reading condition with the previously stored message reading condition.

Finally, at reading step S330 of reading the message, when the object authentication information and the message reading condition have been authenticated and the message has been transmitted, the message reception terminal reads the message.

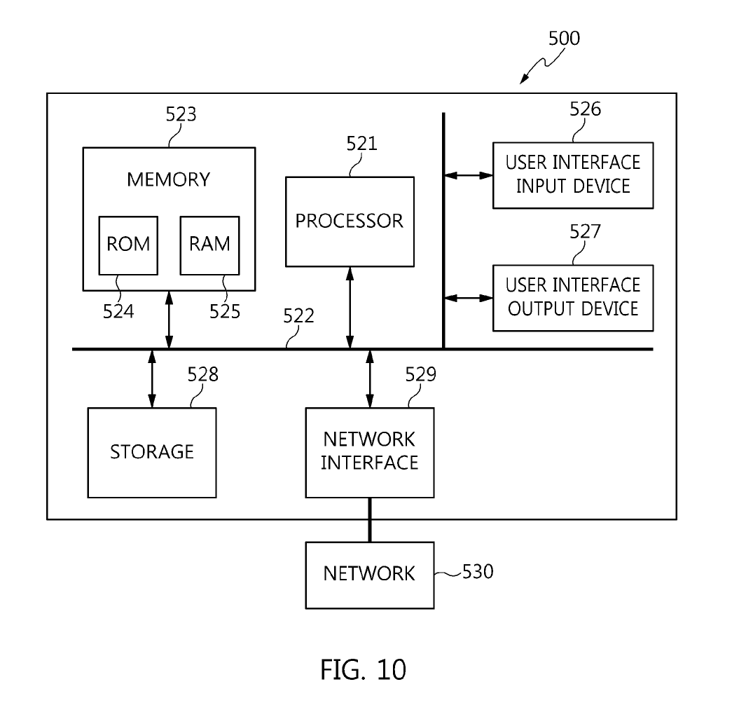

FIG. 10 is an embodiment of the present invention implemented in a computer system.

Referring to FIG. 10, an embodiment of the present invention may be implemented in a computer system, e.g., as a computer readable medium. As shown in in FIG. 10, a computer system 500 may include one or more of a processor 521, a memory 523, a user input device 526, a user output device 527, and a storage 528, each of which communicates through a bus 522. The computer system 500 may also include a network interface 529 that is coupled to a network 530. The processor 521 may be a central processing unit (CPU) or a semiconductor device that executes processing instructions stored in the memory 523 and/or the storage 528. The memory 523 and the storage 528 may include various forms of volatile or non-volatile storage media. For example, the memory may include a read-only memory (ROM) 524 and a random access memory (RAM) 525.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The advantages that are acquired when the apparatus and method for providing a message based on an object configured as described above are applied to real life are described in greater detail below.

First, the system and method according to the present invention can be applied to a case where a gift is transferred. Generally, when a gift is transferred, a letter or a memo is transferred along with the gift. According to the present invention, when a gift is transferred, the corresponding gift is registered in the server, and then a message is generated and registered in the server. In this case, since it is possible to include congratulations or something a user wants to say in the message using various multimedia, the present invention can increase communication capability or effect compared to the conventional memo or letter method. A person who has received the gift can receive and read the message registered in the server by reading the tag attached to the gift or using object identification information. Accordingly, in the case where a person transfers a message that is difficult to transfer in a face-to-face manner or deeper impression is desired, when a message is transferred using the present invention, more improved communication can be achieved.

As another example, the system and method according to the present invention can be applied to tourist spots. Some people want to leave their names or visiting records on rocks, walls, relics and the like in tourist spots. When a method of leaving a message directly on an actual object is used, this method damages the corresponding tourist resource and hurts other persons' feelings. The present invention can be applied to all types of objects or even landscapes. Accordingly, when such a tourist resource is photographed and registered and a message is registered with the corresponding object, the tourist resource can be prevented from being damaged compared to the conventional method, a limitless number of persons can leave messages compared to the conventional method by which only a few persons who have priority can leave messages due to a limited space, and the length of messages has no limitation compared to the conventional method. Accordingly, when the present invention is applied to this field, the present invention can be used as a method for the advertisement, scoring and evaluation, introduction and guest book of a corresponding tourist resource.

As still another example, the system and method according to the present invention can be applied to public facilities. For example, tag-type object identification information is attached to each of the traffic signals distributed across a country and then a message is transferred using this. Currently, when a traffic signal is out of order or is erroneously operating, a contact person or point is not clear, and also it is inconvenient to make a contact. However, when the present invention is applied, a message reception terminal reads a tag and immediately lodges a complaint against a corresponding traffic signal, and a person in charge of the corresponding traffic signal immediately receives the message and identifies the complaint and the corresponding traffic signal. As described above, the system and method according to the present invention can be usefully used to maintain and manage public facilities.

As described above, an apparatus and method for providing a message based on an object according to at least some embodiments of the present invention are advantageous in that the advantages of the conventional non-electronic message transfer method have been combined with the advantages of the advanced electronic message transfer method, thereby achieving the diversity and convenience of communicative expression methods.

an apparatus and method for providing a message based on an object according to at least some embodiments of the present invention are advantageous in that a message can be viewed only when an object is possessed, thereby preventing the loss, damage and theft of the message.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for providing a message based on an object, comprising:
an object management unit configured to perform registration, authentication and deletion of an object based on object identification information and object authentication information transmitted from a message generation terminal;
a message management unit configured to connect a first message and message control information, transmitted from the message generation terminal, to the corresponding object;
a notification processing unit configured to provide notification of arrival of the first message to a message reception terminal based on a message notification condition included in the message control information; and
a reading processing unit configured to process a request from the message reception terminal for reading the first message based on object authentication information and a message reading condition included in the message control information.

2. The apparatus of claim 1, wherein the object identification information is information that is designated by a user or assigned by the apparatus for providing a message based on an object in order to identify the object.

3. The apparatus of claim 1, wherein the object authentication information is information that includes at least one of location information and image information of the object collected from an outside and tag information attached to the object.

4. The apparatus of claim 1, wherein the reading processing unit determines whether authentication is successful by comparing object identification information and object authentication information stored in the object management unit and message reading condition stored in the message management unit with the object authentication information and message reading condition transmitted from the message reception terminal, and transmits the first message.

5. The apparatus of claim 4, wherein the reading processing unit, when the registered object authentication information has been set to image information, computes similarity by comparing the registered object's image with the image transmitted from the message reception terminal, and authenticates the object authentication information if the similarity meets a predefined criteria.

6. The apparatus of claim 4, wherein the reading processing unit, when the registered object authentication information has been set to tag information, compares registered tag information in the object management unit with the tag information of the object transmitted from the message reception terminal, and authenticates the object authentication information if there is a match.

7. The apparatus of claim 4, wherein the reading processing unit, when the registered object authentication information has been set to location information, compares the registered location information in the object management unit with location information transmitted from the message reception terminal, and authenticates the object authentication information if locational similarity meets predefined criteria.

8. The apparatus of claim 1, wherein the message generation terminal comprises:
an object registration unit configured to register the object in the object management unit;
a message generation unit configured to generate the first message through a medium of the object registered in the object management unit;
a message control unit configured to set message control information for the generated first message;
a message transmission request unit configured to request transmission of the first message to the message reception terminal by transmitting the first message and the message control information to the message management unit; and
a message reading unit configured to read a second message transmitted from the reading processing unit.

9. The apparatus of claim 8, wherein the object registration unit comprises:
an input unit configured to receive the object identification information;
a collection unit configured to collect the object authentication information;
a storage unit configured to store the object identification information and the object authentication information;
a communication unit configured to transmit the object identification information and the object authentication information stored in the storage unit to the object management unit, and to receive a result of the registration of the object; and
a display unit configured to output a result of the registration of the object.

10. The apparatus of claim 8, wherein the message control unit sets the message control information, including:
mandatory message information including object identification information, sender identification information, and message content; and
additional message information including object authentication information, message recipient identification information, a message notification condition, and a message reading condition.

11. The apparatus of claim 10, wherein the object authentication information is set as at least one of image information, location information and tag information of the object, the message recipient identification information is information used to set a terminal that receives the message, the message notification condition is a condition used to set arrival notification that enables the message reception terminal to become aware of arrival of the first message, and the message reading condition is a condition used to set time, a location and a character string at which the message reception terminal can read the first message.

12. The apparatus of claim 8, wherein the message reading unit comprises:
a message reception unit configured to receive notification of arrival of the second message transmitted from the notification processing unit;
an object authentication unit configured to acquire the second message and object authentication information of an object used as a medium, to transmit the second message and the object authentication information to the reading processing unit, and to obtain authentication of the second message and the object authentication information;
a reading condition authentication unit configured to transmit the message reading condition to the reading processing unit, and to obtain authentication; and
a reading unit configured to, when the object authentication information and the message reading condition have been authenticated by the reading processing unit, read the second message.

13. The apparatus of claim 8, wherein the first message and the second message are each generated using at least any one of text, a photo, a moving image, and music.

14. A method of providing a message based on an object, comprising:
performing, by an object management unit, registration, authentication and deletion of an object based on object identification information and object authentication information transmitted from a message generation terminal;
connecting, by a message management unit, a first message and message control information, transmitted from the message generation terminal, to the corresponding object;
providing, by a notification processing unit, notification of arrival of the first message to a message reception terminal based on a message notification condition included in the message control information; and
processing, by a reading processing unit, a request from the message reception terminal for reading the first message based on object authentication information and a message reading condition included in the message control information.

15. The method of claim 14, wherein processing a request from the message reception terminal for reading the first message based on object authentication information and a message reading condition included in the message control information comprises:
determining whether authentication is successful by comparing object identification information and object authentication information stored in the object management unit and a message reading condition stored in the message management unit with the object authentication information and the message reading condition transmitted from the message reception terminal, and transmitting the first message.

16. The method of claim 15, wherein when the registered object authentication information has been set to image information, computing similarity by comparing the registered object's image with the image transmitted from the message reception terminal, and authenticating the object authentication information if the similarity meets predefined criteria.

17. The method of claim 15, wherein when the registered object authentication information has been set to tag information, comparing registered tag information in the object management unit with the tag information of the object transmitted from the message reception terminal, and authenticating the object authentication information if there is a match.

18. The method of claim 15, wherein when the registered object authentication information has been set to location information, comparing the registered location information in the object management unit with location information transmitted from the message reception terminal, and authenticating the object authentication information if locational similarity meets predefined criteria.
